(19) United States
(12) Patent Application Publication
(10) Pub. No.: US 2025/0191859 A1
(43) Pub. Date: Jun. 12, 2025

(54) SNAP-ACTION SWITCH BOX FOR ROTATABLE ELECTRIC CONTACTS, PARTICULARLY FOR DISCONNECTORS

(71) Applicant: BREMAS ERSCE S.P.A., Cambiago (IT)

(72) Inventor: Franco CIVETTINI, Castel Mella (IT)

(21) Appl. No.: 18/846,519

(22) PCT Filed: Sep. 23, 2022
(86) PCT No.: PCT/EP2022/076586

§ 371 Date: Sep. 12, 2024

(30) Foreign Application Priority Data
Mar. 16, 2022 (IT) 102022000005087

(51) Int. Cl. H01H 19/64

(52) U.S. Cl. CPC H01H 19/64

(57) ABSTRACT

A snap-action switch box includes a base, a loading spindle, an indexing element associated rotatably with both, and a helical torsion spring which is mounted on the indexing element so that it can be loaded by a rotation of the loading spindle about a central axis. The spring has two stems which protrude from respective end turns of the spring and the indexing element includes at least two abutments which protrude in an eccentric position and in opposite directions and are substantially parallel to the central rotation axis. The stems of the spring are adapted to abut respectively against the abutments.

### CROSS-REFERENCE TO RELATED APPLICATIONS

This application is a 35 U.S.C. § 371 National Stage patent application of PCT/EP2022/076586, filed on 23 Sep. 2022, which claims the benefit of Italian patent application 102022000005087, filed on 16 Mar. 2022, the disclosures of which are incorporated herein by reference in their entirety.

### TECHNICAL FIELD

The present disclosure relates to a snap-action switch box for the snap-action rotation of rotatable electric contacts, particularly for disconnectors, and to a disconnector comprising said snap-action switch box.

### BACKGROUND

In electrical distribution lines and in industrial applications, disconnectors are used to safely break a circuit, typically for maintenance purposes.

For example, in a photovoltaic system the photovoltaic cells, the photovoltaic modules that comprise them, and the strings of said photovoltaic modules can be protected, or disconnected, by means of disconnectors, which substantially are manually-operated rotary switches. Disconnectors of a known type which can incorporate the present disclosure are described in EP2853012B1 in the name of this same Applicant and are formed by a plurality of substantially identical modular contact boxes stacked on top of each other. Each contact box, also termed module or layer, generally comprises a rotatable contact and a pair of fixed contacts. The group rotation of the rotatable contacts allows to interrupt or allow the flow of current in an extremely short time between the two fixed contacts of each contact box.

This rotation is imposed manually by means of a snap-action switch box, which is located at the top of the stack of contact boxes and comprises an actuation shaft which can be actuated by the user. The rotation started by the user leads to a progressive loading of a spring, which, once a certain angle of rotation has been exceeded, is rapidly relieved, thereby triggering the rotation of a driven shaft which is fixed to the rotatable contacts and returning the spring to the inactive or preloading condition.

Known snap-action switch boxes can be, for example, like the one described in patent application GB1159729, in which an elastic metal indexing element is coaxially associated with the rotatable contacts and is shaped substantially like a horseshoe with raised free ends, so that the interspace between the free ends can affect four fixed raised portions, which are angularly mutually spaced and are adapted to prevent the rotation of the indexing element, particularly during the loading of a coil spring associated with an actuation knob. The lowering of one of the free ends of the indexing element by a tooth eccentrically associated with the actuation knob releases the indexing element, which, propelled by the release of the coil spring, triggers the rotation of the rotatable contacts until the indexing element is blocked by the next raised portion.

One drawback of known snap-action switch boxes is that the use of metal components inside them requires the provision of additional electrical insulations to prevent the risk of current transmission from the rotatable contacts to the snap-action switch box. This complicates their manufacture and assembly.

The assembly of the components of known snap-action switch boxes is not easy also due to the fact that the torsion springs must be mounted in a very specific orientation, thus slowing down production.

In known switch boxes that can be actuated in both directions of rotation of the actuation knob, it is furthermore necessary to provide torsion springs of a special type and/or more than one torsion spring.

### SUMMARY

The aim of the present disclosure is to provide a snap-action switch box, particularly for disconnectors and more particularly for DC disconnectors for photovoltaic applications, that is capable of improving the background art in one or more of the aspects mentioned above.

Within this aim, the disclosure provides a snap-action switch box with a reduced number of metallic elements with respect to known snap-action switch boxes.

The disclosure also simplifies the assembly of the components of a snap-action switch box, particularly for disconnectors.

In particular, the disclosure allows for an assembly of the snap-action switch box that does not require to take into consideration the orientation of the torsion spring.

The disclosure further avoids the use of special torsion springs in the snap-action switch box.

The present disclosure also provides a snap-action switch box in which it is possible to use a single torsion spring of the type commonly commercially available or easy to provide.

The disclosure further uses a smaller number of components of the snap-action switch mechanism with respect to known solutions.

A still further object of the present disclosure is to overcome the drawbacks of the background art in a manner that is alternative to any existing solutions.

Not least of the disclosure is to provide a snap-action switch box, particularly for disconnectors and even more particularly for DC disconnectors for photovoltaic applications, that is highly reliable, relatively easy to provide and at competitive costs.

This aim and these and other advantages that will become better apparent hereinafter are achieved by providing a snap-action switch box according to the claims, optionally provided with one or more of the characteristics of the dependent claims.

### BRIEF DESCRIPTION OF THE DRAWINGS

Further characteristics and advantages of the disclosure will become better apparent from the description of a preferred but not exclusive embodiment of the snap-action switch box according to the disclosure, illustrated by way of non-limiting example in the accompanying drawings, wherein:

FIG. 1 is a view of a disconnector provided with a snap-action switch box according to the disclosure;

FIGS. 2a, 2b, 2c are exploded views of the snap-action box of FIG. 1, in different perspectives;

FIGS. 3a-3b are a side view and an axial sectional view, respectively, of the switching assembly of the snap-action switch box of the preceding figures;

FIGS. 4a-4b are a side view, which is diametrically opposite with respect to that of FIG. 3a, and the respective axial sectional view;

FIGS. 5a-5b are exploded views, but without the spring, of the switching assembly of the preceding figures;

FIGS. 6a-6d are various perspective views, from above and below, of the driven indexing element of the snap-action switch box of the preceding figures;

FIG. 7 is a view of the loading spindle of the switching assembly of the preceding figures;

FIG. 8 is a bottom plan view of the covering element of the snap-action switch box of the preceding figures;

FIG. 9 is a top plan view of the base of the snap-action switch box of the preceding figures;

FIG. 10 is a top plan view of one of the modular contact boxes of the disconnector of FIG. 1; and

FIG. 11 is an exploded view of the contact box of the preceding figure.

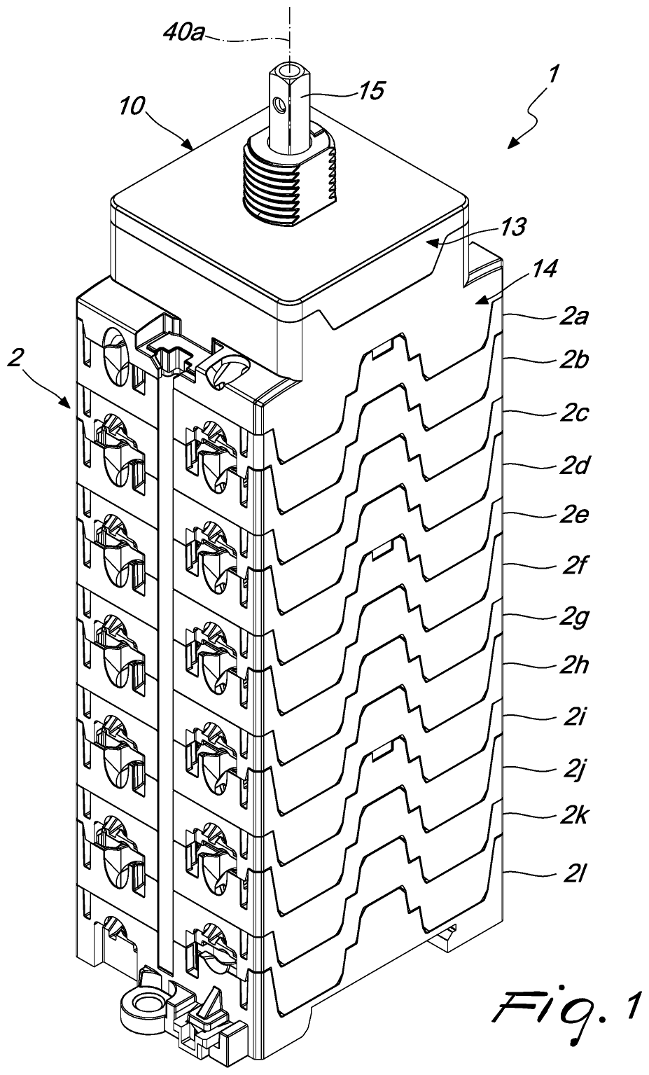

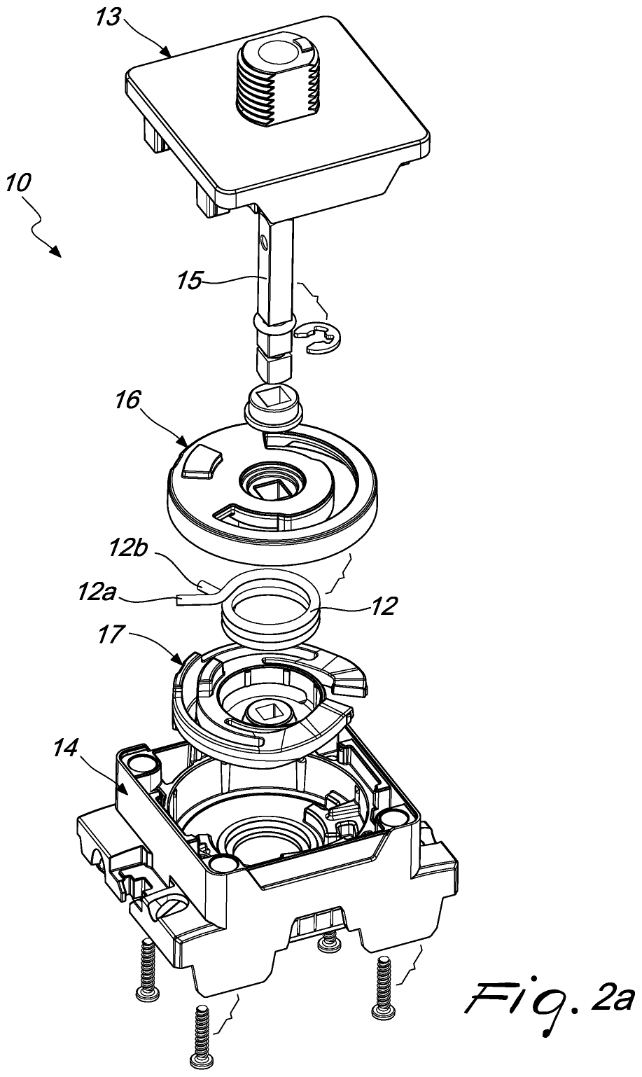

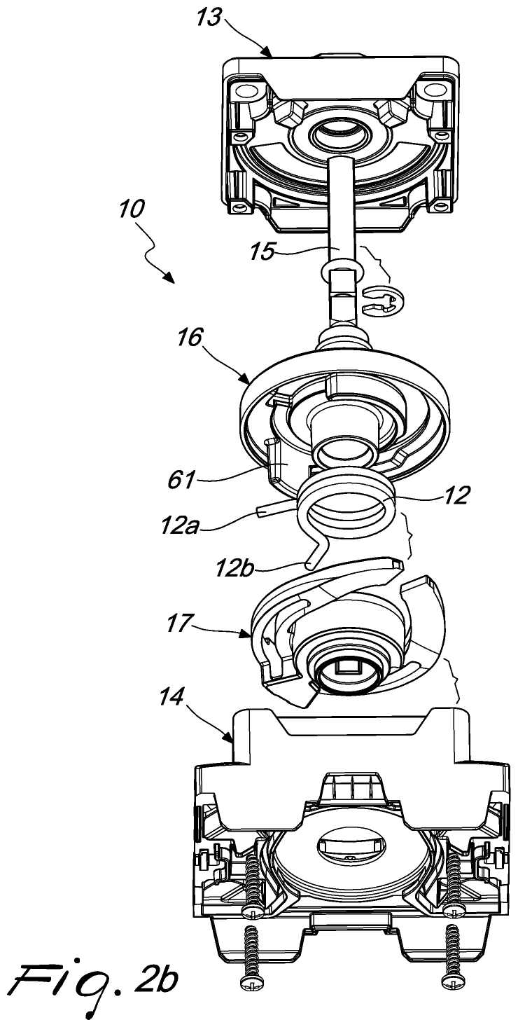

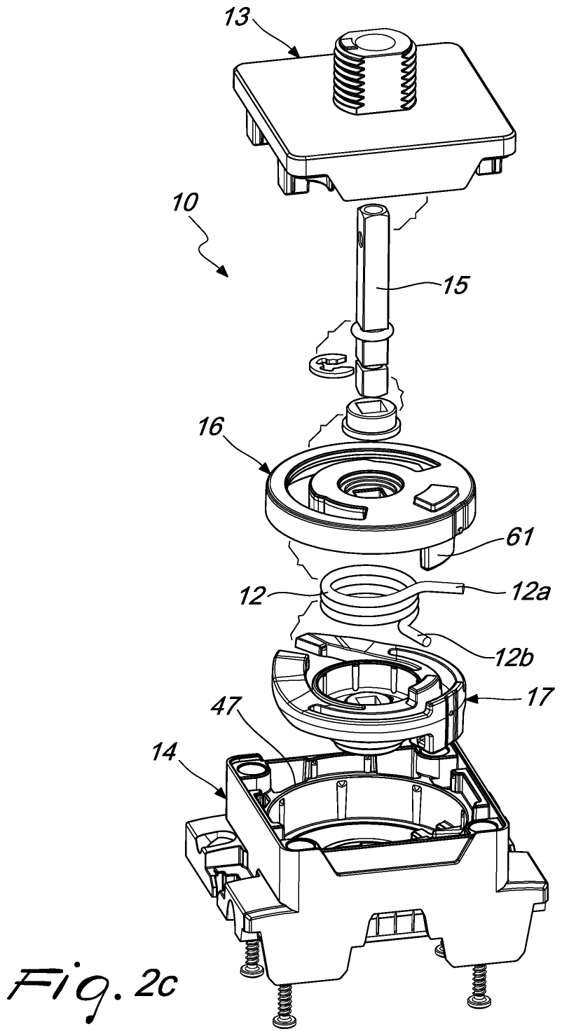

### DETAILED DESCRIPTION OF THE DRAWINGS

With reference to the figures, a DC disconnector 1 comprising a snap-action switch box 10 according to an embodiment of the disclosure is formed by a stack 2 of modular contact boxes 2a, 2b, . . . , 2l. The modular contact boxes 2a-2l can be of a type that is per se known, for example, from patent EP2853012B1 in the name of the same Applicant and can be in any number, according to the requirements.

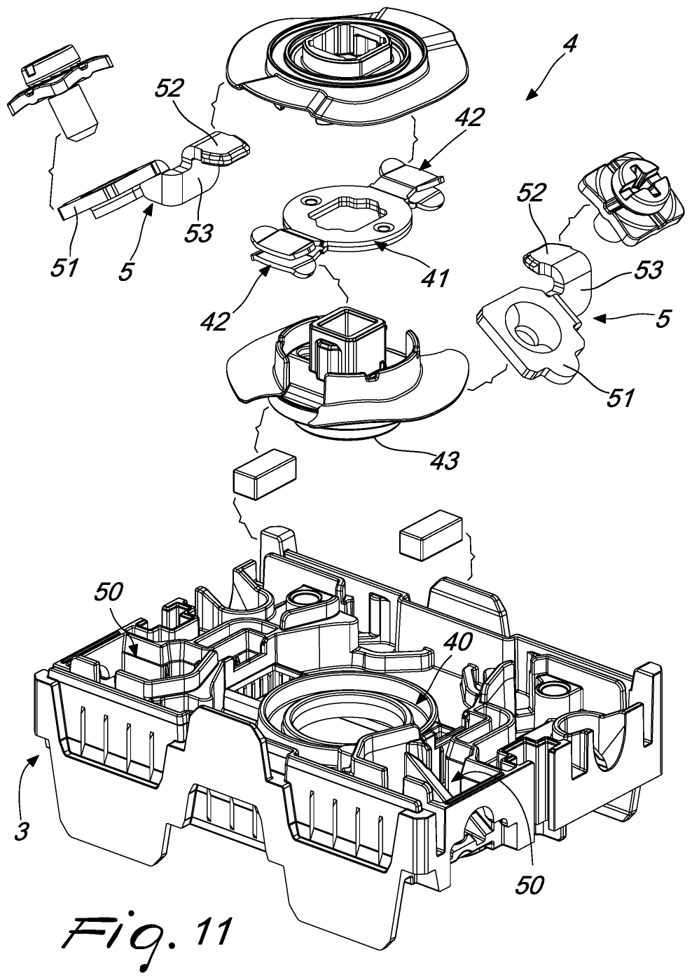

Assuming, for the sake of simplicity in description, that the contact boxes 2a-2l are mutually identical, each one can comprise an accommodation body 3 (FIGS. 10-11) which defines a through central seat 40, for a rotatable electric contact 4, and two peripheral seats 50, each of which accommodates a connecting portion 51 of a fixed electric contact 5 which can be accessed from the outside of the modular contact box 2a-2l. The rotatable contact 4 can rotate about a central axis 40a of the central seat 40 with respect to the accommodation body 3, in order to engage, only in predefined angular positions, with the fixed contacts 5, which are arranged with their connecting portion 51 in the peripheral seats 50. Said predefined angular positions are mutually spaced by 180° with respect to the axis 40a.

The accommodation body 3, with the rotatable contact 4 and the fixed contacts 50, defines the (modular) contact box 2a, 2b, . . . , also termed herein “module” or “layer”.

Each fixed contact 5 comprises a connecting portion 51, a contact portion 52 and a connection portion 53 that extends between the connecting portion 51 and the contact portion 52. The contact portion 52 of the fixed contact 5 is adapted to establish an electrical contact with the rotatable contact 4, while the connecting portion 51 is accessible from the outside of the modular contact box 2a-2l and from the outside of said disconnector 1. The contact portions 52 are arranged in the accommodation body 3 so as to be in diametrically opposite positions with respect to the axis 40a.

The rotatable contact 4 comprises a conducting metallic portion 41 which defines two electric end portions 42, preferably in the form of terminals or blades in diametrically opposite positions with respect to the axis 40a and adapted to make direct electrical contact with the contact portions 52 of the fixed contacts 5 of the respective module, depending on their angular position around the axis 40a.

Each rotatable contact 4 comprises, moreover, a central through hole 45, which is coaxial to the rotation axis 40a that is common to all the modules 2a-2l when the rotatable contact 4 is mounted in the central seat 40 of the respective contact box of the stack 2.

The rotatable contacts 4 of the contact boxes 2a-2l are mutually integral so as to rotate together about the axis 40a following a rotation imposed by the snap-action switch box 10 on the rotatable contact 4 that is nearest to the switch box 10. For example, a single connecting rod passing through the central holes 45 of all the rotatable contacts 4 and actuatable by a driven element of the snap-action switch box 10 can be used.

The snap-action switch box 10, according to one embodiment of the disclosure, is substantially closed except at the crossings of the rotation axis 40a and comprises internally a switching assembly 11, which is accommodated between a covering element 13 and a base 14 which define the internal volume of the switch box 10. The base 14 and the corresponding covering element 13 are both made of polymeric material and are mutually fixed, for example by means of screws.

The covering element 13 is crossed axially by an actuation shaft 15 of the switching assembly 11. The actuation shaft 15 can be operated manually by a user, for example by means of a knob (not shown). The actuation shaft 15 is rigidly fixed to a loading spindle 16 of an individual helical torsion spring 12, which is advantageously cylindrical.

The switching assembly 11 also comprises a driven indexing element 17 rotatably associated with the base 14 and with the loading spindle 16 so that it can rotate, with respect to both the base 14 and the loading spindle 16, about the central rotation axis 40a. Advantageously, the indexing element 17 and the loading spindle 16 are both made entirely of polymeric material and can be manufactured by molding. The spindle 16 and the indexing element 17 are contained axially by the covering element 13 and by the base 14, in order to prevent their mutual spacing in an axial direction.

The helical torsion spring 12 is mounted on the indexing element 17 so that it can be loaded by a rotation of the loading spindle 16 with respect to the indexing element 17 about the central axis 40a.

The helical torsion spring 12 comprises two stems 12a-12b, which protrude from respective turns at the axially opposite ends of the spring 12 and away from its axis. The stems 12a-12b protrude (radially, as in the case shown, or tangentially or transversely) from the respective end turns of the spring 12 in a substantially mirror-symmetrical manner, so that the spring 12 can be used in the switching assembly 11 equally in one position or in the corresponding inverted position, substantially coaxially to the rotation axis 40a. In this manner, the assembly of the spring is simplified, since it is not necessary to consider the orientation that said spring must have when it is to be mounted in the indexing element 17. In other words, it is possible to mount the same torsion spring 12 also in an inverted position with respect to the one shown in the drawings without modifying the operation of the snap-action switch box.

According to one aspect of the disclosure, the indexing element 17 comprises at least two abutments 71 and 72, which protrude from the indexing element 17 in an eccentric position and in opposite directions which are substantially parallel to the central rotation axis 40a. The first abutment 71 protrudes toward the loading spindle 16, while the second abutment 72 protrudes from the indexing element 17 away from the loading spindle 16.

The stems 12a, 12b protrude from the respective end turns of the torsion spring 12 so as to abut laterally against a respective abutment 71 and 72, in particular on opposite sides with respect to an imaginary plane that passes through the two abutments 71 and 72 and through the central axis 40a. The abutments 71 and 72 are arranged on the indexing element 17 so that, preferably in an inactive or preloading condition of the torsion spring 12, any one of the stems 12a-12b can abut against a lateral abutment edge 71a of the abutment 71 and the other one of the stems 12a-12b can abut consequently against a lateral abutment edge 72b of the other abutment 72. For this purpose, the distance in the axial direction between the abutments 71a and 72b can be substantially equal to the axial extension of the helical torsion spring 12.

The first abutment 71 can optionally comprise two lateral abutments edges 71a and 71b which are substantially parallel to each other and are mutually angularly spaced with respect to the center of the indexing element 17. The second abutment 72 also can optionally comprise two lateral abutment edges 72a-72b which are mutually angularly spaced with respect to the center of the indexing element 17 and are spaced from the first pair of abutments 71a-72b in a direction that is parallel to the central axis 40a. In this manner, the same indexing element 17 can be used with different helical torsion springs, for example with opposite winding directions with respect to the one shown in the drawings.

Advantageously, the indexing element 17 comprises a cylindrical seat 73, which is coaxial to the central rotation axis 40a and in which the helical torsion spring 12 is accommodated with its stems 12a-12b in abutment against the abutments 71 and 72. The seat 73 is substantially cup-shaped and has advantageously a bottom 73a on which a transmission rod (not shown) can be fixed which can be connected rigidly to at least one rotatable electric contact 4, for example, by shape mating.

The indexing element 17 (which, seen in plan view, has a substantially circular profile) comprises advantageously a circumferential arc-like slot 74 centered on the central axis 40a and having a greater radius than the seat 73 of the spring 12, so that the arc-like slot 74 partially surrounds the seat 73.

The stems 12a-12b of the spring protrude from the end turns of the spring 12 so as to be arranged in a bridge-like arrangement on the arc-like slot 74 when they are in abutment against the respective abutments 71 and 72.

Along the seat 73, particularly between its side wall and the bottom 73a, a slot 73b is preferably provided in order to allow the crossing of the stem 12b that is in the lowest position and the relative movement between said stem 12b and the indexing element 17, for example when the torsion spring 12 is loaded by pushing the stem 12b.

The abutments 71 and 72 are aligned under each other, parallel to the central axis 40a, and have advantageously the same width. In the illustrated embodiment, the second abutment 72 is substantially a cylindrical sector which is arranged in a bridge-like arrangement below the arc-like slot 74, while the first abutment 71 is substantially split on either side of the slot 74 on the upper part of the indexing element so that its lateral abutments are substantially coplanar to those of the second abutment 72. In this manner, the stems 12a and 12b have a greater abutment surface.

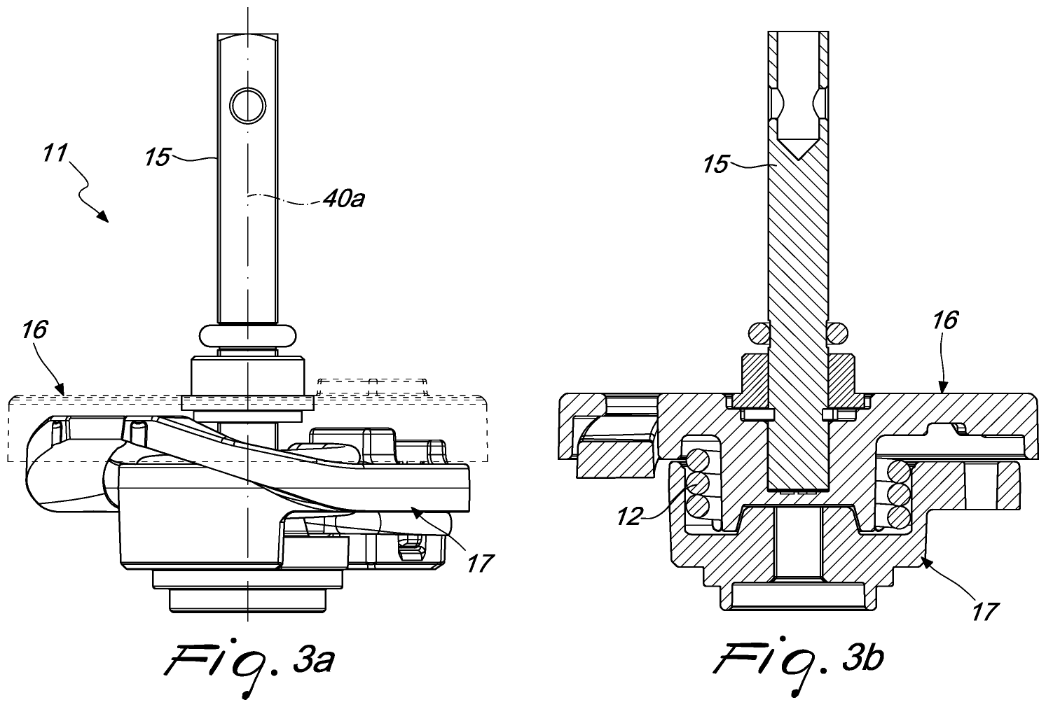

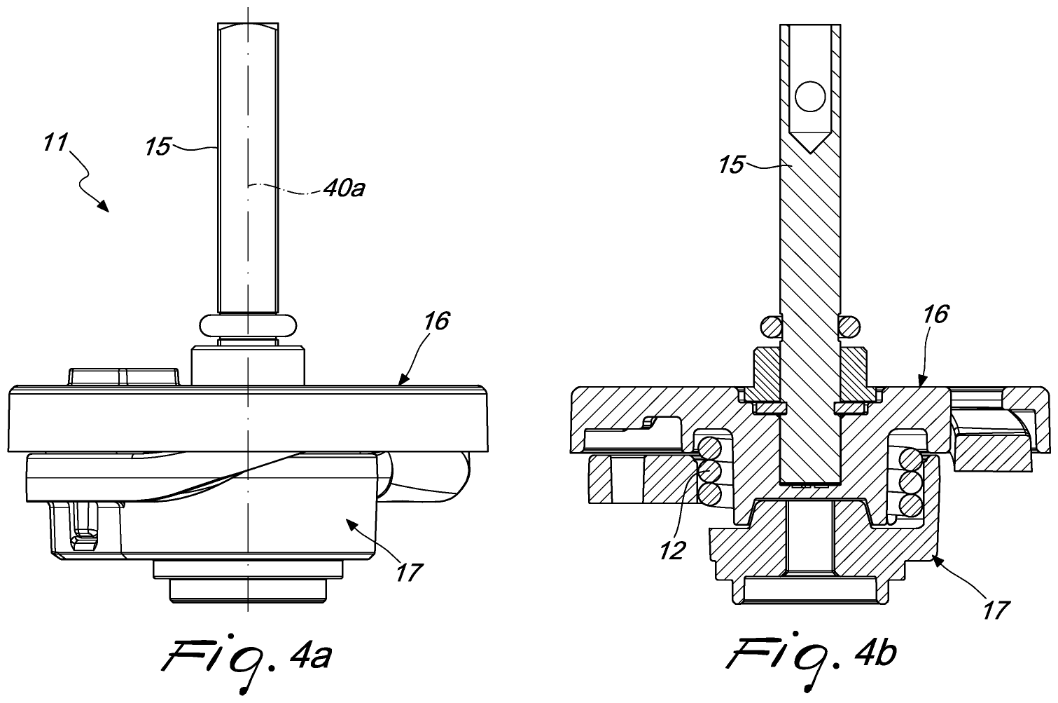

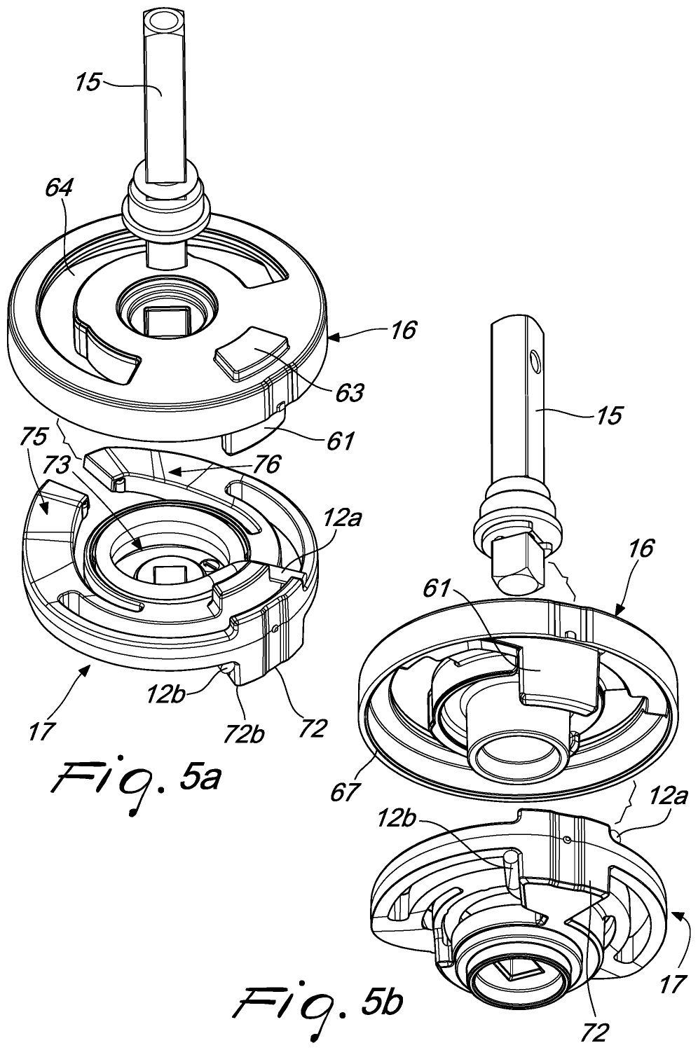

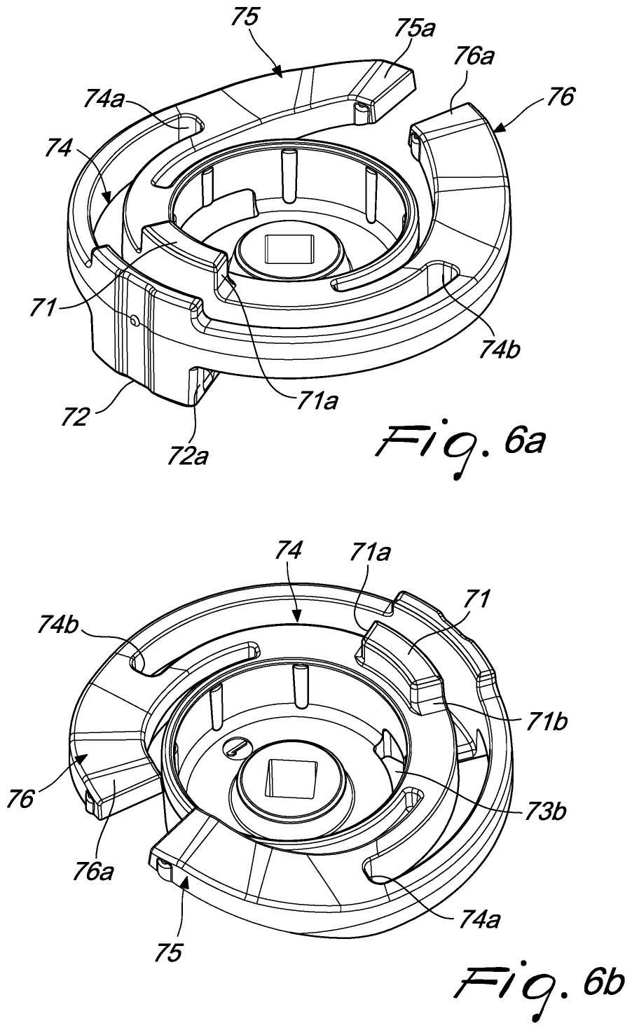

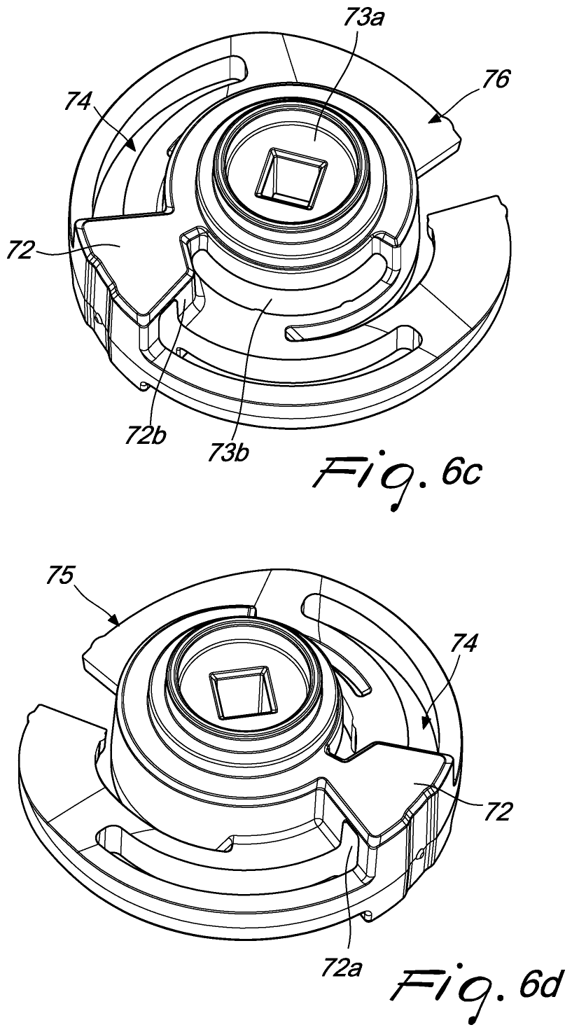

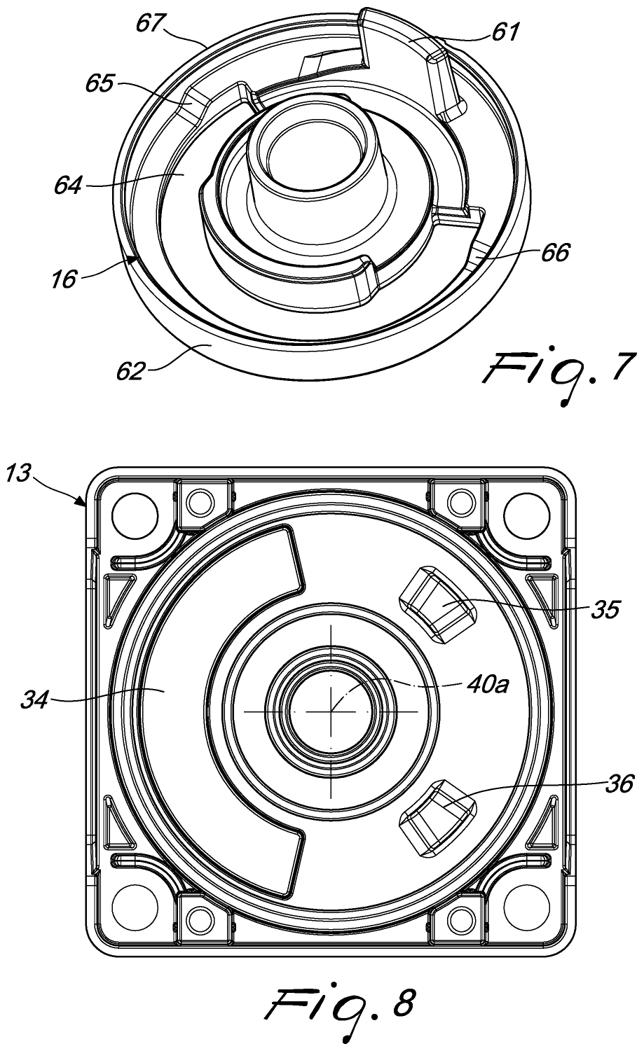

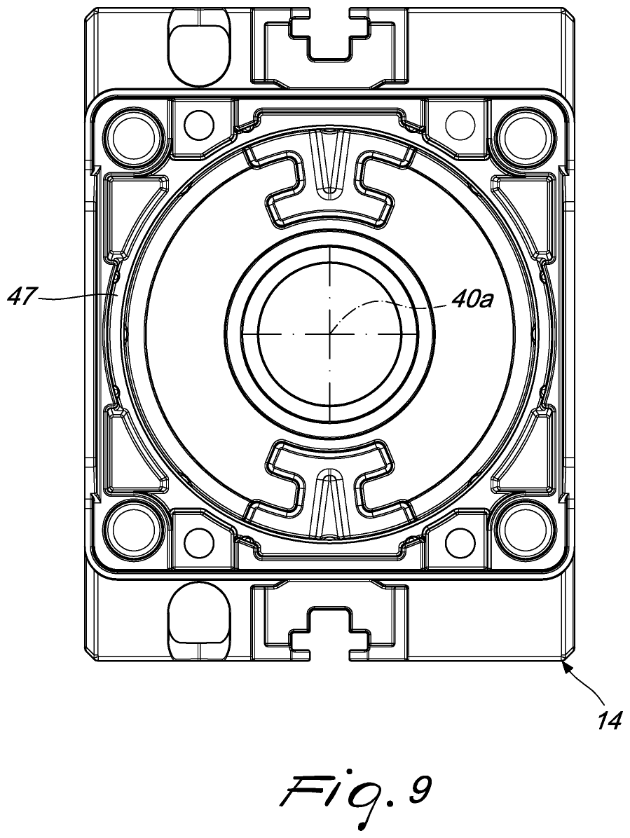

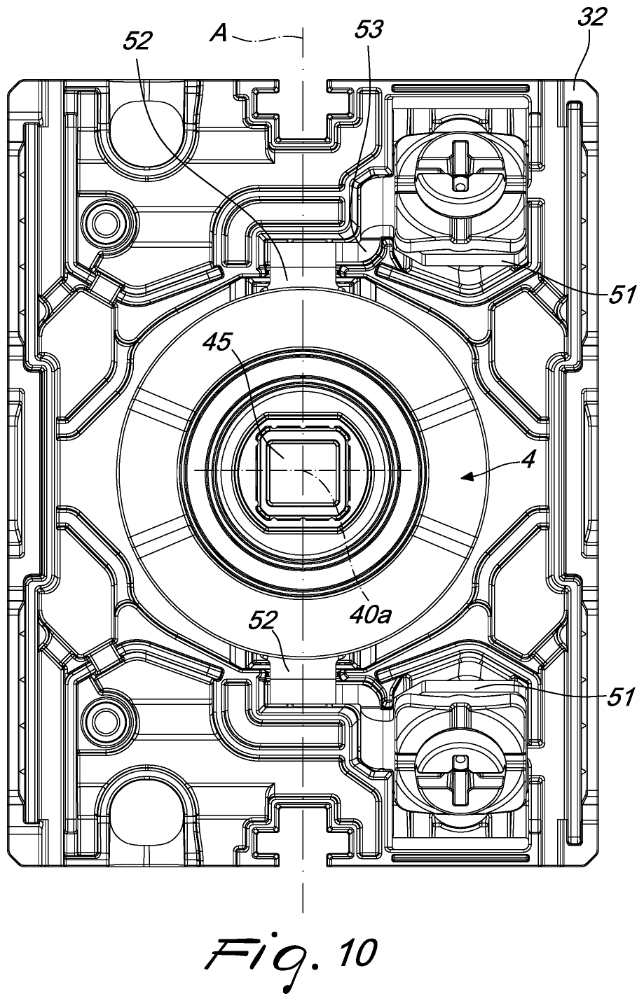

The loading spindle 16 also has a circular shape (in particular, along its external perimeter) and is coupled rotatably to the bottom 73a of the seat 73 of the indexing element 17. As shown in the sectional views of FIGS. 3b and 4b, the rotatable coupling between the loading spindle 16 and the indexing element 17 is such to define between them a cylindrical interspace that is coaxial to the seat 73 and in which the turns of the helical torsion spring 12 are accommodated.

The loading spindle 16 comprises a loading tab 61, which is in an eccentric position with respect to the central axis 40a at a distance from said axis 40a that is substantially equal to the radius of curvature of the arc-like slot 74 of the indexing element. The loading tab 61 protrudes from the loading spindle 16 with such an axial extension as to pass through the arc-like slot 74 and be able to affect one or the other of the stems 12a-12b depending on the rotation direction of the loading spindle 16 with respect to the indexing element 17 about the central axis 40a. In stable conditions, i.e., in the ON or OFF positions of the switch box 10 in which the torsion spring 12 is in an inactive or preloading condition, the loading tab 61 is axially aligned and angularly centered with respect to the abutments 71 and 72 and is interposed between the stems 12a and 12b.

The loading tab 61 has a width substantially equal to or smaller than the width of the abutments 71 and 72 in a circumferential direction.

Preferably, the loading spindle 16 has, on the opposite face with respect to the one from which the tab 61 protrudes, a raised portion 63 adapted to engage slidingly within a corresponding arc-like guide 34 of the covering element 13, in order to guide the rotation of the loading spindle 16 about the central axis 40a.

The indexing element 17 is advantageously provided with two pawl-like arms 75 and 76, which are elastically flexible in a direction that is substantially parallel to the central axis 40a and are adapted to affect indexing teeth 35 and 36 provided in fixed positions in the switch box 10. Preferably, the indexing teeth 35 and 36 protrude from below the covering element 13 in positions that are radially equidistant from the central axis 40a.

The pawl-like arms 75 and 76 extend toward each other in a substantially mirror-symmetrical manner starting from respective ends 74a and 74b of the arc-like slot 74. The seat 73 of the spring 12 is thus surrounded partially by the arc-like slot 74 and partially by the pawl-like arms 75 and 76.

Moreover, the pawl-like arms 75 and 76 extend away from the indexing element 17 so that they are elastically flexible in a direction that is parallel to the central axis 40a.

The extension in the axial direction of the pawl-like arms 75 and 76 is such that the respective free ends 75a and 76a of the arms can abut laterally against each indexing tooth 35 and 36 in order to prevent the rotation of the indexing element 17 about the central axis 40a, particularly during the loading of the spring 12 which is performed by the spindle 16.

In order to allow the interaction between the ends 75a and 76a of the pawl-like arms 75-76 and the fixed indexing teeth 35 and 36, the loading spindle 16 comprises advantageously an arc-like window 64 which is concentric to the central axis 40a and which, in the switch box 10, is crossed by the indexing teeth 35 and 36. The arc-like window 64 is spaced from the central axis 40a like the indexing teeth 35 and 36 and is adapted to leave the free ends 75a-76a of the pawl-like arms at least partially exposed, so as to make them abut laterally against the one or the other of the indexing teeth 35-36. The arc-like window 64 is centered in a diametrically opposite position with respect to the position of the loading tab 61 and is extended through a center angle of at least 180°. In the inactive or preloading condition of the spring 12, the interspace between the free ends 75a and 76a of the pawl-like arms is positioned substantially halfway along the arc-like window 64, i.e., at 180° from the loading tab 61 with respect to the central axis 40a. A similar position halfway along the arc-like window 64 is provided for one of the indexing teeth 35.

Along the circumferential edge of the arc-like window 64, cams 65 and 66 (for example, in the form of respective mutually opposite ramps) are advantageously provided; at said ramps, the thickness of the loading spindle 16 along the arc-like window 64 increases toward the indexing element 17. The cams 65 and 66 are adapted to affect a respective free end 75a and 76a of the pawl-like arms 75 and 76 in order to push the respective pawl-like arm away from the arc-like window 64 during a rotation of the loading spindle 16 with respect to the indexing element 17 that loads the torsion spring 12 with respect to its initial inactive or preloading condition. This pushing action removes the interference with the respective indexing tooth 35 or 36 by the free end of the arm 75 or 76 that is pushed by the cam and consequently frees the release of the torsion spring 12, which triggers the rotation of the indexing element 17 with respect to the spindle 16. Said release rotation stops as soon as the pawl-like arms affect the other indexing tooth 36 or 35, returning the spring 12 to a stable inactive or preloading condition.

The maximum diameter of the loading spindle 16 is advantageously larger than the maximum diameter of the indexing element 17 (when they are seen in plan view, from above or below), so that the loading spindle 16 can contain circumferentially the free rotation of the indexing element 17 (in particular of the pawl-like arms 75 and 76) about the axis 40a. Preferably, the loading spindle 16 may comprise a cylindrical or (slightly) frustoconical skirt 62 having a diameter adapted to surround from the outside the indexing element 17 (particularly the free ends 75a and 75b of the pawl-like arms along the entire circumference of their rotational trajectory about the axis 40a). The cylindrical skirt 62 has a rim 67 that rests on a corresponding inner cylindrical wall 47 of the base 14 of the snap-action switch box. When the switching assembly 11 is mounted on the base 14, the inner cylindrical wall 47 has a height substantially equal to that of the indexing element 17 but lower than the height (in the axial direction) of the free ends 75a and 76a of the pawl-like arms 75 and 76, which are instead laterally enclosed by the skirt 62. With this arrangement it is possible to avoid an additional fixed element in the snap-action switch box 10 designed solely to contain laterally the indexing element 17, although the loading spindle 16 may consequently be larger in diameter than the one that would be strictly necessary to load the spring 12.

The operation of the snap-action switch box according to the disclosure is evident from what has been described above.

In practice it has been found that the disclosure achieves the intended aim and objects, providing a snap-action switch box in which the metallic elements are limited to only the helical torsion spring and optionally also to the actuation shaft and the clamping screws, while the rotating elements of the switching assembly, plus of course the base and the covering element of the box, are made entirely of polymeric material, i.e., electrically insulating material.

The disclosure thus conceived is susceptible of numerous modifications and variations, all of which are within the scope of the appended claims; all the details may furthermore be replaced with other technically equivalent elements.

1-11. (canceled)

12. A snap-action switch box, particularly for disconnectors, comprising a base, a loading spindle and an indexing element which is associated rotatably with said base and with said loading spindle so that the indexing element can rotate with respect to the base and the loading spindle about a central rotation axis, said switch box comprising a helical torsion spring which is mounted on said indexing element so that it can be loaded by a rotation of said loading spindle about said central rotation axis, wherein said spring comprises a first stem which protrudes from one end turn of the helical torsion spring and a second stem which protrudes from a turn of an axially opposite end of the helical torsion spring, and wherein said indexing element comprises at least two abutments which protrude in an eccentric position and in opposite directions which are substantially parallel to the central rotation axis, said stems being configured to abut respectively against said abutments.

13. The switch box according to claim 12, wherein said loading spindle comprises a loading tab which is in an eccentric position with respect to said central rotation axis and is extended toward said indexing element so as to move at least one of said stems away from the respective abutment following a relative rotation between the loading spindle and the indexing element about the central rotation axis.

14. The switch box according to claim 13, wherein said loading tab is interposed between the stems of the helical torsion spring and has such a length as to affect one or another of said stems depending on a direction of said relative rotation.

15. The switch box according to claim 12, wherein said indexing element comprises an arc slot which is extended in a radially equidistant manner about said central rotation axis, said stems protruding from the respective end turns of the spring so as to be arranged in a bridge arrangement on said arc slot.

16. The switch box according to claim 15, wherein said loading tab protrudes from said loading spindle so as to pass through said arc slot.

17. The switch box according to claim 12, wherein said indexing element comprises at least two elastically flexible pawl arms which are configured to affect indexing teeth provided in fixed positions in the switch box, and wherein said pawl arms extend toward each other and away from the indexing element, so as to be elastically flexible in a direction that is parallel to said central rotation axis in order to release a snap-action coupling between the pawl arms and an indexing tooth.

18. The switch box according to claim 15, wherein said indexing element comprises a seat which is coaxial to the central rotation axis and in which said helical torsion spring is accommodated with said stems abutting against said abutments.

19. The switch box according to claim 18, wherein said seat of the helical torsion spring is partly surrounded by said arc slot and partly by said pawl arms.

20. The switch box according to claim 17, wherein said loading spindle comprises an arc window which is concentric to said central rotation axis, is crossed by said indexing teeth and is configured to leave free ends of said pawl arms exposed so as to make said free ends abut laterally against said indexing teeth, at least one pair of mutually opposite cams being provided along said arc window in order to push a respective pawl arm away from said arc window during a rotation of said loading spindle with respect to said indexing element.

21. The switch box according to claim 20, wherein said arc window is centered in a diametrically opposite position with respect to the position of said loading tab on said loading spindle.

22. A disconnector particularly for photovoltaic applications, comprising one or more modular contact boxes which are surmounted by a snap-action switch box according to claim 12, each modular contact box comprising an accommodation body which has a central seat which accommodates a rotatable contact and two peripheral seats, each of which accommodates a connecting portion of a respective fixed contact which can be accessed from the outside of said modular contact box, said rotatable contact being rotatable with respect to said accommodation body about said central rotation axis in order to engage/disengage with respect to the fixed contacts, each rotatable contact being rigidly coupled in rotation to said indexing element.
